(19) United States
(12) Patent Application Publication
(10) Pub. No.: US 2021/0198080 A1
(43) Pub. Date: Jul. 1, 2021

(54) AN ELEVATOR SYSTEM, TEST SYSTEM, DOOR BLOCKAGE DETECTION SYSTEM, EMERGENCY CALL HANDLER SYSTEM, CALLER UNIT, MONITORING SYSTEM, AND ASSOCIATED METHODS

(71) Applicant: AVIRE LIMITED, Maidenhead Berkshire (GB)

(72) Inventor: Robert Lewis, Maidenhead Berkshire (GB)

(21) Appl. No.: 16/754,448

(22) PCT Filed: Sep. 28, 2018
(86) PCT No.: PCT/GB2018/052776

§ 371 Date: Apr. 8, 2020

(30) Foreign Application Priority Data
Oct. 11, 2017 (GB) 1716671.1

(51) Int. Cl. B66B 5/00; B66B 3/00; B66B 1/34; B66B 13/22; B66B 5/02

(52) U.S. Cl. CPC B66B 5/0018; B66B 3/00; B66B 1/3461; H04L 67/12; B66B 1/3492; B66B 5/02; B66B 13/22

(57) ABSTRACT

An elevator test unit for testing the operation of an elevator system, the test unit including: a first input configured to receive a command input instructing the performance of a test operation in relation to an elevator car associated with the test unit; a first output configured, in response to receipt of the command input at the first input, to cause the generation of a first level request signal or a first simulated level request signal to be sent to a main elevator controller to cause the test operation; a second input configured to receive an indication of whether the test operation occurred successfully; and a second output configured to output a report based on the received indication.

### TECHNICAL FIELD

Embodiments of the present invention relate to an elevator system, test system, door blockage detection system, emergency call handler system, caller unit, monitoring system, and associated methods.

### BACKGROUND

Elevator systems are typically maintained by service engineers who are not based in the same geographical location as the elevator system—e.g. not in the same building as the elevator system. These service engineers may be responsible for the maintenance of a large number of elevator systems which may be spread over a wide geographical region.

When an issue is identified (e.g. by the owner, manager, or operator of the building which is serviced by the elevator system), then the service engineer is contacted and the service engineer schedules a visit to the location of the elevator system to perform unplanned maintenance to address the identified issue.

If the elevator system is operating normally when the service engineer inspects the system, then the service engineer may have been contacted needlessly. The visit by the service engineer may likewise have been unnecessary.

It is not uncommon for service engineers to be unable to identify a fault with the elevator system during such unplanned maintenance visits. This results in a not inconsiderable waste of resources and may be generally referred to as ‘false callouts’.

In many instances, false callouts are a result of user interference with the operation of the elevator system and this is perceived as a fault by other users of the elevator system.

For example, a user preventing a door of an elevator from closing on one level of a building may be perceived as a fault by a user waiting for that elevator on another level of the building.

In some other instances, a false callout may occur due to malicious reporting of an alleged fault by a user.

There is a need therefore to alleviate one or more problems associated with the prior art.

### SUMMARY

Accordingly, an aspect of the invention provides an elevator test unit for testing the operation of an elevator system, the test unit including: a first input configured to receive a command input instructing the performance of a test operation in relation to an elevator car associated with the test unit; a first output configured, in response to receipt of the command input at the first input, to output a signal to cause the generation of a first level request signal or a first simulated level request signal to be sent to a main elevator controller to cause the test operation; a second input configured to receive an indication of whether the test operation occurred successfully; and a second output configured to output a report based on the received indication.

The test unit may be configured to be mounted to the elevator car.

The first output may be communicatively coupled to a car operating panel of the elevator car and the signal may be configured to cause the generation of the first level request signal from the car operating panel.

The first output may be communicatively coupled to the main elevator controller and the signal may be the first simulated level request signal.

The second output may be communicatively coupled to a caller unit associated with the elevator car, and the caller unit may be configured to handle one or more emergency communication functions.

An elevator test unit may further include an operation determining sub-system which may be communicatively coupled to the second input and which may be configured to output the indication of whether the test operation occurred successfully.

The operation determining sub-system may include one or more of an acceleration sensor, an air pressure sensor, an encoded position indicator reader, and a door switch.

The indication of whether the test operation occurred successfully may include an indication of a movement of the elevator car and/or the operation of an elevator door of the elevator car.

The first output may be configured to cause the generation of a second level request signal to be sent to a main elevator controller, wherein the first level request signal may be different to the second level request signal.

The first output may be configured to cause the generation of a second simulated level request signal to be sent to a main elevator controller, wherein the first simulated level request signal may be different to the second simulated level request signal.

The test unit may be configured to generate the input command after a predetermined period has passed since an event detected by the test unit.

The test unit may be configured to detect a plurality of events, to determine a peak period based on the detected events, and to set the predetermined period based on the determined peak period.

Another aspect provides an elevator test system including: an elevator test unit; and a call handler system located remotely from the elevator system.

The call handler system may be configured to output the command input to the first input.

The call handler system may be configured to output the command input in response to an emergency call made using an emergency intercom system associated with the elevator car.

Another aspect provides an elevator test method for testing the operation of an elevator system, the test method including: a receiving, at a first input of a test unit, a command input instructing the performance of a test operation in relation to an elevator car associated with the test unit; causing, in response to receipt of the command input at the first input, the outputting of a signal, from a first output of the test unit, to generate a first level request signal or a first simulated level request signal to be sent to a main elevator controller to cause the test operation; receiving, at a second input, an indication of whether the test operation occurred successfully; and outputting, from a second output, a report based on the received indication.

Another aspect provides an elevator door blockage detection system configured to determine whether an elevator door is performing a nudge operation, the system being configured to: receive an indication from a door sensor that there is an obstruction in a door aperture of the elevator door; receive an indication from the door sensor that the elevator door is moving towards a closed configuration; and based at least in part on the received indications from the door sensor, determine that a nudge operation is being performed.

The system may be further configured to receive one or more further indications from the door sensor regarding movement of the elevator door, and wherein determining that a nudge operation is based at least in part on the one or more further indications.

The system may be further configured, when a nudge operation is determined to be performed, to output a report to a caller unit for transmission to a remote call handler system.

The system may be further configured to transmit a report to a call handler system when a nudge operation is determined to be performed.

The system may be further configure to output an audible alarm when a nudge operation is determined.

The indication that the elevator door is moving towards a closed configuration may include an indication of the width of a door aperture of the elevator door.

The width may be a minimum width achieved by the elevator door during movement towards the closed configuration.

The system may be further configured to compare the width in relation to two consecutive determined nudge operations and to output a temporary blockage report if the widths are not substantially equal.

The system may be further configured to compare the width in relation to two consecutive determined nudge operations and to output a blockage report if the widths are substantially equal.

The system may be further configured to output an audible alarm when a temporary blockage report or blockage report is output.

Another aspect provides a combination including the: elevator door blockage detection system, and at least one of the door sensor and a caller unit.

Another aspect provides an elevator door blockage detection method for determining whether an elevator door is performing a nudge operation, the method including: receiving an indication from a door sensor that there is an obstruction in a door aperture of the elevator door; receiving an indication from the door sensor that the elevator door is moving towards a closed configuration; and based at least in part on the received indications from the door sensor, determining that a nudge operation is being performed.

The method may further include receiving one or more further indications from the door sensor regarding movement of the elevator door, and wherein determining that a nudge operation may be based at least in part on the one or more further indications.

The method may further include, when a nudge operation is determined to be performed, outputting a report to a caller unit for transmission to a remote call handler system.

The method may further include transmitting a report to a call handler system when a nudge operation is determined to be performed.

The method may further include outputting an audible alarm when a nudge operation is determined.

The indication that the elevator door may be moving towards a closed configuration may include an indication of the width of a door aperture of the elevator door.

The width may be a minimum width achieved by the elevator door during movement towards the closed configuration.

The method may further include comparing the width in relation to two consecutive determined nudge operations and outputting a temporary blockage report if the widths are not substantially equal.

The method may further include comparing the width in relation to two consecutive determined nudge operations and outputting a blockage report if the widths are substantially equal.

The method may further include outputting an audible alarm when a temporary blockage report or blockage report is output.

Another aspect provides an elevator emergency call handler system configured to: receive a call triggered by actuation of an emergency intercom button in an elevator car associated with the emergency call handler system; receive an indication of at least one of: the current configuration or status of an elevator door associated with the elevator car, and a movement or location of the elevator car; and selectively perform one of: sending a predetermined message to an emergency intercom system associated with the elevator car for output using the emergency intercom system, and connecting the emergency intercom system with an operator, depending on the received indication.

The indication may be an indication of whether the elevator door is in an open configuration or a closed configuration.

The indication may be an indication of whether a door sensor of associated with the elevator car detects an obstruction within a door aperture of the elevator door.

Another aspect provides an elevator emergency call handler method, the method including: receiving a call triggered by actuation of an emergency intercom button in an elevator car associated with the emergency call handler system; receiving an indication of at least one of: the current configuration or status of an elevator door associated with the elevator car, and a movement or location of the elevator car; and selectively performing one of: sending a predetermined message to an emergency intercom system associated with the elevator car for output using the emergency intercom system, and connecting the emergency intercom system with an operator, depending on the received indication.

The indication may be an indication of whether the elevator door is in an open configuration or a closed configuration.

The indication may be an indication of whether a door sensor of associated with the elevator car detects an obstruction within a door aperture of the elevator door.

Another aspect provides a caller unit configured to be mounted with respect to an elevator car, the caller unit being configured to be communicatively coupled to an emergency intercom button and an emergency intercom system of the elevator car, wherein the caller unit is further configured to: initiate a call to a remote call handler system on actuation of the emergency intercom button; send to the call handler system an indication of at least one of: the current configuration or status of an elevator door associated with the elevator car and a movement or location of the elevator car; and receive an signal from the call handler system and to output that signal using the emergency intercom system.

The indication may be an indication of whether the elevator door is in an open configuration or a closed configuration.

The indication may be an indication of whether a door sensor of associated with the elevator car detects an obstruction within a door aperture of the elevator door.

Another aspect provides a method of operating a caller unit, the caller unit being configured to be mounted with respect to an elevator car, the caller unit being further configured to be communicatively coupled to an emergency intercom button and an emergency intercom system of the elevator car, wherein the method includes: initiating a call to a remote call handler system on actuation of the emergency intercom button; sending to the call handler system an indication of at least one of: the current configuration or status of an elevator door associated with the elevator car, and a movement or location of the elevator car; and receiving an signal from the call handler system and to output that signal using the emergency intercom system.

The indication may be an indication of whether the elevator door is in an open configuration or a closed configuration.

The indication may be an indication of whether a door sensor of associated with the elevator car detects an obstruction within a door aperture of the elevator door.

Another aspect provides a method of operating a caller unit configured to be mounted with respect to an elevator car, the caller unit being configured to be communicatively coupled to an emergency intercom button and an emergency intercom system of the elevator car, wherein the method includes: detecting actuation of the emergency intercom button; triggering a test operation of the elevator car based at least in part on the detection of the actuation of the emergency intercom button; receiving an indication of whether the test operation completed successfully; and initiating a call to a remote call handler system selectively based on the received indication.

The test operation may include opening an elevator door of the elevator car.

The test operation may include movement of the elevator car to another level.

The initiation of the call may be triggered when the test operation fails.

Another aspect provides a caller unit configured to be mounted with respect to an elevator car, the caller unit being configured to be communicatively coupled to an emergency intercom button and an emergency intercom system of the elevator car, wherein the caller unit is further configured to: detect actuation of the emergency intercom button; trigger a test operation of the elevator car based at least in part on the detection of the actuation of the emergency intercom button; receive an indication of whether the test operation completed successfully; and initiate a call to a remote call handler system selectively based on the received indication.

The test operation may include opening an elevator door of the elevator car.

The test operation may include movement of the elevator car to another level.

The initiation of the call may be triggered when the test operation fails.

Another aspect provides an elevator monitoring system configured to collate information generated by the test unit, the test system, the blockage detection system, the combination, the emergency call handler system, or the caller unit, and to deliver all of part of the collated information to another device.

The other device may be a device which is remote from the elevator monitoring system.

Another aspect provides an elevator system including the test unit, the test system, the blockage detection system, the combination, the emergency call handler system, or the caller unit, and to deliver all of part of the collated information to another device.

Another aspect provides an elevator emergency call handler system configured to: initiate a contact attempt to a remote operator periodically; record a response from the remote operator when the contact request is successful; and perform at least one of sending the recorded response to a caller unit mounted with respect to an elevator car for output using an emergency intercom system of the elevator car, and notifying another device of the success or failure of the contact attempt.

Another aspect provides an elevator emergency call handler method, including: initiating a contact attempt to a remote operator periodically; recording a response from the remote operator when the contact request is successful; and performing at least one of sending the recorded response to a caller unit mounted with respect to an elevator car for output using an emergency intercom system of the elevator car, and notifying another device of the success or failure of the contact attempt.

### BRIEF DESCRIPTION OF THE DRAWINGS

Embodiments are described, by way of example only, with reference to the accompanying drawings, in which:

FIG. 1 shows a schematic simplified view of an elevator system;

FIGS. 2a-d show a simplified view of an elevator car door opening;

FIG. 3 shows a simplified view of a building with levels serviced by an elevator system;

FIG. 4 shows a schematic view of a car operating panel;

FIG. 5 shows a schematic view of an elevator door and associated components;

FIG. 6 shows a schematic view of some embodiments of a test unit;

FIG. 7 shows a schematic view of some embodiments of a door blockage detection system; and

FIG. 8 shows a monitoring system.

### DESCRIPTION

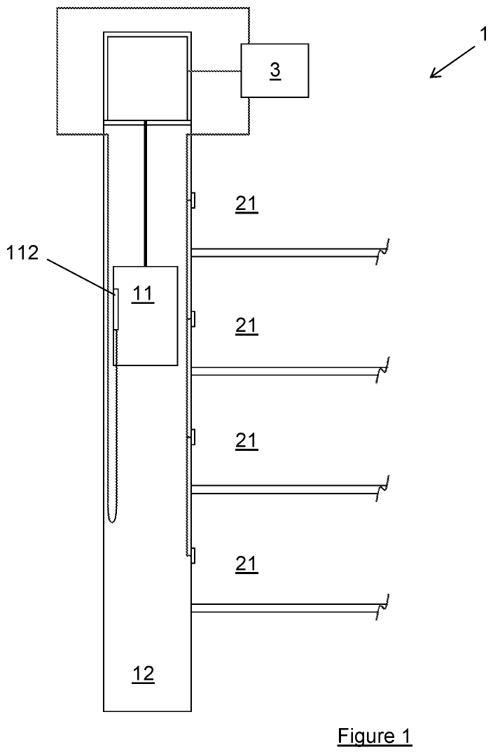

With reference to FIG. 1, for example, an elevator system 1 may include one or more elevator cars 11 each provided in a respective elevator shaft 12.

The elevator system 1 may be fitted to a building 2 or other facility which has a plurality of different levels 21. The elevator system 1 may be configured to serve each of the plurality of levels 21 to allow users and/or objects to travel between levels 21.

The or each elevator car 11 includes an elevator door 111 which can be moved between open and closed configurations to enable access to the elevator car 11 selectively. The elevator door 111 may be a sliding door which moves between the open and closed configurations through a linear movement.

In some embodiments, the elevator door 111 is provided in at least two parts which retract in opposing directions when moving from the closed to the open configuration, and extend towards each other when moving from the open to the closed configuration (i.e. a centre opening arrangement). Each part of the elevator door 111 may be provided as a plurality of sections, each section may move in a linear manner with respect to one or more other sections of the same part of the elevator door 111 (in a sliding movement). A similar arrangement of sections may be used for a side opening arrangement of an elevator door 111—i.e. an elevator door 111 which includes a single part, which may be formed of multiple sections, which extends across the entire door opening when in the closed configuration.

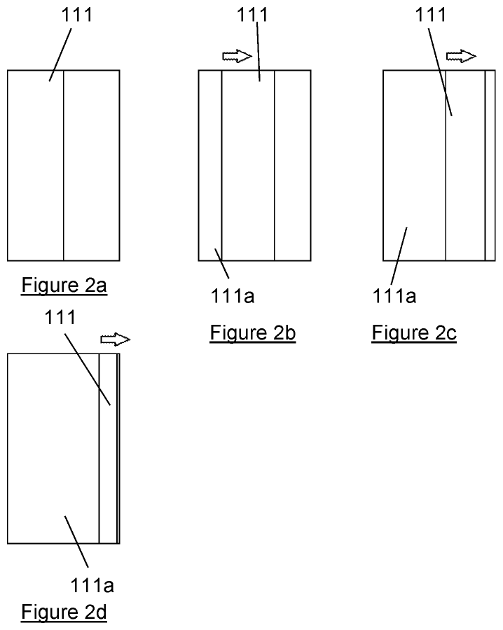

Accordingly, a relatively large door aperture 111 a may be provided by the overlapping position of the door sections when in the open configuration (the door aperture 111a being the opening of the door 111 at any given time and so reaches a maximum with the elevator door 111 in its open configuration and a minimum with the elevator door 111 in its closest configuration). This can be seen in FIGS. 2a-2d, for example.

The elevator door 111 may be configured to interact with an elevator shaft door such that the elevator door 111 operates synchronously with the elevator shaft door (moving between the open and closed configurations) when the elevator door 111 is adjacent the elevator shaft door. An elevator shaft door may be associated with each level 21 which is served by the elevator system 1. Accordingly, when the elevator car 11 stops at a particular level 21, the elevator door 111 may be generally adjacent an elevator shaft door for the level 21. The elevator door 111 and adjacent elevator shaft door may then be operate synchronously to allow access between the elevator car 11 and the level 21—i.e. to allow users and/or objects to enter or leave the elevator car 11.

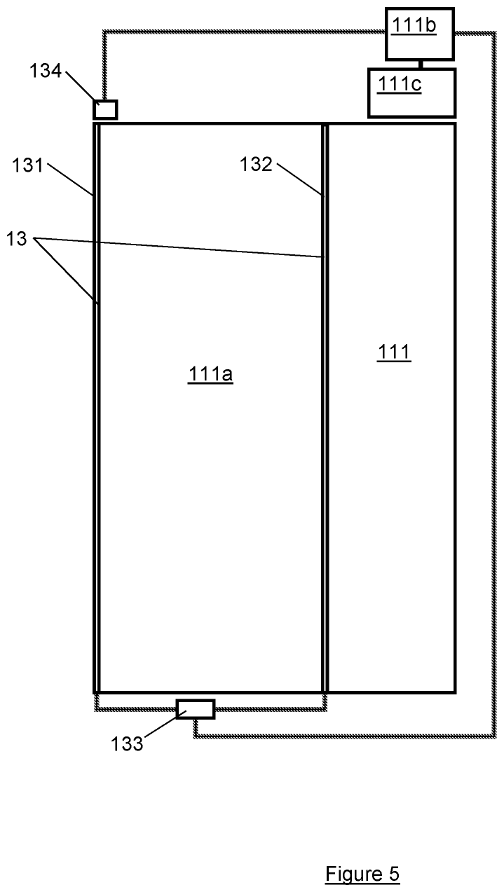

The or each elevator door 111 is associated with a respective door sensor 13 (see FIG. 5). The door sensor 13 is configured to detect one or more objects which would obstruct the movement of the elevator door 111 (and/or the elevator shaft door) to the closed configuration. In other words, the door sensor 13 associated with the or each elevator door 111 is configured to detect and object which may be hit by the movement of the elevator door 111 towards the closed configuration.

The or each door sensor 13 may be communicatively coupled to a door controller 111b which is, in turn, communicatively coupled to a door driving mechanism 111c which is configured to drive the movement of the elevator door 111 from the open to the closed configuration (and potentially also from the closed to the open configuration).

On the sensing of an obstruction, the door sensor 13 which sensed the obstruction may send a signal to the door controller 111b which may, in turn, operate the door driving mechanism 111c to cease movement of the elevator door 111 towards the closed configuration and/or to reverse the movement of the elevator door 111 back towards the open configuration.

The or each door sensor 13 may be provided to prevent or reduce the risk of injury or damage to users or objects which may obstruct the operation of the elevator door 111. Indeed, users may even deliberately place an object or a part of their body in the path of the elevator door 111 whilst it is moving towards its closed configuration in order to cause the elevator door 111 to re-open—relying on the aforementioned operation of the door sensor 13.

The door sensor 13 may be mounted to the elevator car 11 (e.g. to the elevator door 111 (such as to the parts of the elevator door 111 or to the part of the elevator door 111 and to a slam post)). The door sensor 13 may be mounted to the leading edge or edges of the elevator door 111.

Alternatively, the door sensor 13 may be mounted to the elevator shaft door 111.

Mounting the door sensor 13 to the elevator car 11 means that the same door sensor 13 is used irrespective of the level 21 at which the elevator car 11 is located. If a door sensor 13 is mounted to each elevator shaft door, then there will need to be multiple door sensors 13 (one for each level 21 for each elevator shaft 12).

Due to the synchronous movement of the elevator doors 111 and elevator shaft doors, both are generally indicated with the same reference numeral in the figures.

The door sensor 13 could take a number of different forms. For example, the door sensor 13 may comprise an infrared door sensor 13 which has at least one infrared transmitter 131 (located on a first side of the door aperture 111a) and at least one infrared receiver 132 (located on a second, opposing, side of the door aperture 111a). An obstruction between the transmitter 131 and receiver 132 will be detected due to a change in received infrared light by the receiver 132. A corresponding signal will then be provided to the door controller 111b, as described herein.

The door sensor 13 may, therefore, provide a light curtain across the door aperture 111a—which may not be a visible light curtain. Disturbance (i.e. interruption) of the light curtain by an object is sensed by the door sensor 13 as an obstruction.

In some embodiments, the transmitter 131 is provided by a plurality of transmitter elements such as diodes. Likewise, the receiver 132 may be provided by a plurality of receiver elements such as diodes.

An object which obstructs part of the light curtain may, therefore, block the light path between the transmitter 131 and receiver 132 in relation to some of the transmitter and receiver elements—i.e. a partial obstruction. This may be an obstruction of a lower, middle, or upper part of the light curtain, for example.

In some embodiments, a door sensor controller 133 is provided. The door sensor controller 133 may be part of the door sensor 13. The door sensor controller 133 may be configured to control one or more aspects of the operation of the door sensor 13. These one or more aspects may include the operation of the transmitter 131 and/or receiver 132 and/or any communication of the door sensor 13 to the door controller 111b (to control the operation of the door driving mechanism 111c).

The door sensor controller 133 may be communicatively coupled (e.g. by a wired or wireless communication channel) to a main elevator controller 3 of the elevator system 1 which is configured to control the operation of one or more aspects of the elevator system 1. The main elevator controller 3 may include various inputs and outputs, as well as configuration interfaces, and the like, which enable the main elevator controller 3 to control the operation of the elevator system 1 and to allow an engineer to configure one or more part of the elevator system 1.

The elevator system 1 may include door switch 134 which is configured to provide an indication of the current configuration (open or closed) of the elevator door 111 of a particular elevator car 11. As such, in some embodiments, each elevator car 11 may be associated with at least one door switch 134. The output or outputs from the or each door switch 134 may be communicatively coupled to the door sensor controller 133 and/or to the main elevator controller 3. The output or outputs from the or each door switch 134 may be used to confirm that the elevator door or doors 111 have moved to the closed configuration before the elevator car or cars 11 are moved within the elevator shaft 12. Likewise, in some embodiments, the output or outputs from the or each door switch 134 may be used to confirm that the elevator door or doors 111 have moved to the open configuration on arrival at a level 21, for example (and/or in response to a call signal even if the elevator car 11 did not have to move between levels to service the call signal).

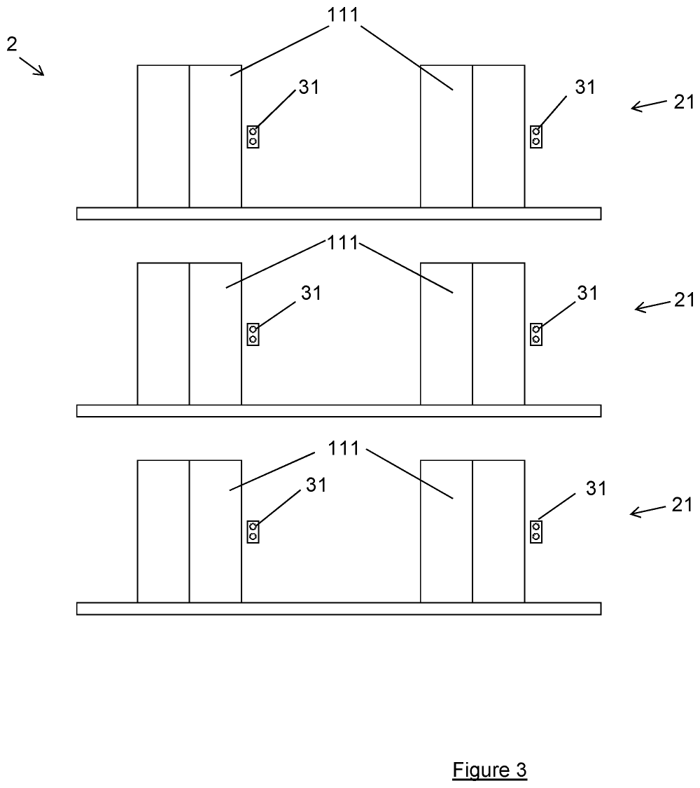

The elevator system 1 may include one or more call buttons 31—see FIG. 3. One or more levels 21 serviced by the elevator system 1 may be associated with a respective call button 31 of the one or more call buttons 31. The or each call button 31 may be located adjacent or in the region of the elevator shaft 21 (and may be located adjacent the elevator shaft door(s) 111). The or each call button 31 may be communicatively coupled to the main elevator controller 3.

Actuation of one of the one or more call buttons 31 provides the main elevator controller 3 with an indication that an elevator car 11 is required on the associated level 21. This indication is referred to as a call signal. At least one of the one or more call buttons 31 may include a pair of buttons which can be used to provide directional information as to the desired direction of travel (e.g. up or down) by user actuation of one of the pair of buttons. This information may be passed to the main elevator controller 3 in the call signal.

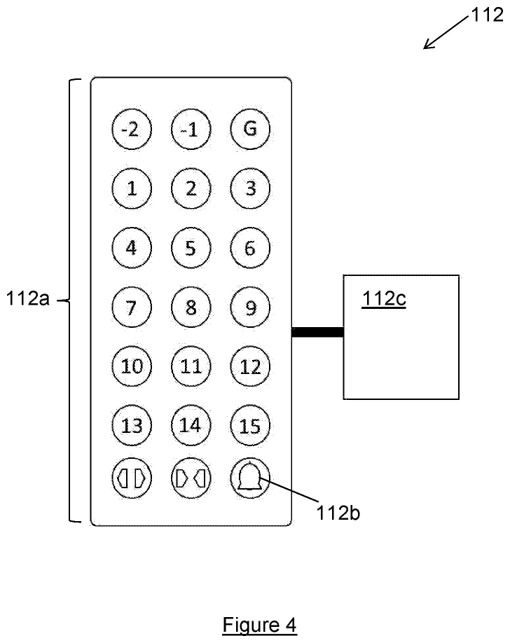

The or each elevator car 11 may include a car operating panel 112 (see FIG. 4), which may be communicatively coupled to the main elevator controller 3. The car operating panel 112 may include a plurality of buttons 112a. These buttons 112a may represent the levels 21 which are serviced by the elevator system 1 and/or the elevator car 11 in which the car operating panel 112 is provided. Accordingly, actuation of a button of the plurality of buttons 112a of the car operating panel 112 may cause a corresponding level request signal to be sent to the main elevator controller 3. A user may, therefore, actuate a button of the plurality of buttons 112a indicating the level 21 to which they would like the elevator car 11 to travel.

Accordingly, a user may actuate a call button 31 and the main elevator controller 3 may cause the movement of an elevator car 11 to the level 21 associated with the call button 31. On arrival of the elevator car 11 at that level 21, the elevator door 111 may open to allow the user to enter the elevator car 11. On entry, the user may actuate a button of the plurality of buttons 112a of the car operating panel 112 to indicate the level 21 to which they would like to travel and the main elevator controller 3 may cause movement of the elevator car 11 to that level 21 (after the elevator door 111 has closed).

The plurality of buttons of the car operating panel 112 may include, for example, an emergency intercom button 112b. In addition, the car operating panel 112 may include or may be coupled to an emergency intercom system 112c. The emergency intercom system 112c may include a microphone and a speaker, for example. The emergency intercom system 112c is, as will be understood, associated with the elevator car 11 in which it is installed.

The elevator system 1 may include one or more caller units 14. In some embodiments, each elevator car 11 is associated with a respective caller unit 14 of the one or more caller units 14. The caller unit 14 associated with a particular elevator car 11 may be a top of car unit—i.e. secured to the top of the elevator car 11. In other embodiments, the caller unit 14 may be located in a different position with respect to the elevator car 11 with which it is associated. The or each caller unit 14 may be configured to handle one or more emergency communication functions (including the provision of communication between a remote operator and a user of the elevator system 1 through the emergency intercom system 112c, for example).

The caller unit 14 for a particular elevator car 11 may be communicatively coupled to the emergency intercom system 112c and/or the emergency intercom button 112b. Accordingly, actuation (e.g. by a user) of the emergency intercom button 112b may trigger activation and/or operation of the caller unit 14.

The caller unit 14 may be communicatively coupled to a call handler system 15. The call handler system 15 may be a remotely located call handler system 15 which is remote from the building serviced by the elevator system 1. The call handler system 15 may be configured to answer a call from the caller unit 14. The call from the caller unit 14 may be initiated on activation or operation of the caller unit 14 (e.g. as triggered by actuation of the associated emergency intercom button 112b). The call handler system 15 may be configured to allow an operator to communicate with a user within the elevator car 11.

Accordingly, the call handler system 15 and the caller unit 14, as part of the call, may communicate audio signals therebetween. In particular, the audio received by the emergency intercom system 112c may be sent to the call handler system 15 and audio received (e.g. from an operator) at the call handler system 15 may be sent to the emergency intercom system 112c.

Therefore, in an emergency a user can initiate a call using the emergency intercom button 112b and may communicate with an operator via the emergency intercom system 112c and the call hander system 15.

The caller unit 14 associated with a particular elevator car 11 may be located, for example, in a machine room associated with the elevator system 1. In some embodiments, the caller unit 14 may be provided within the elevator car 11 (e.g. behind the car operating panel 112. In some embodiments, caller units 14 may be provided in multiple locations—e.g. carried by the elevator car 11 and in a machine room and/or in the elevator shaft 12.

The caller unit 14 or units 14 may be communicatively coupled to the call handler system 15 by a wired or wireless network (or a combination of a wired and a wireless network). The wireless network may include a cellular telephone network, for example.

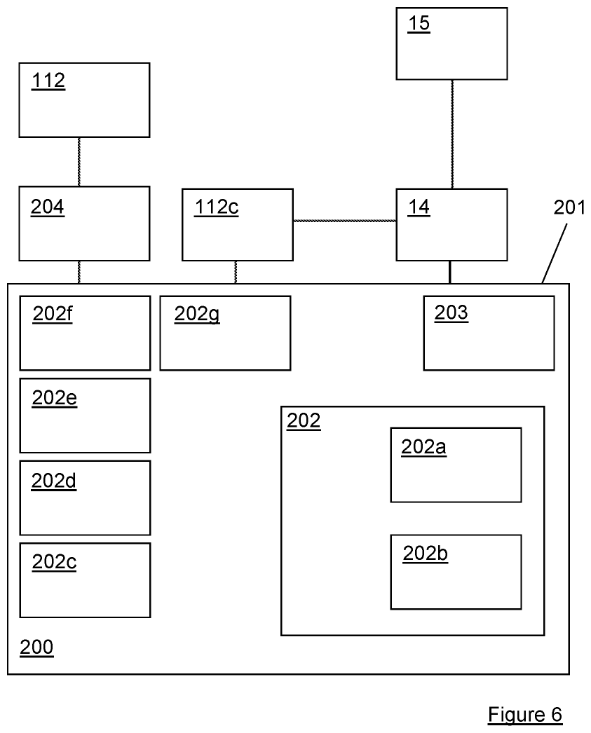

In some embodiments, there is provided a test unit 200 (see FIG. 6). The test unit 200 may be provided as part of the elevator system 1 or may be retrofitted to an existing elevator system 1. In some embodiments, the test unit 200 may be provided as part of the caller unit 14, for example.

The test unit 200 is configured to receive a test command and to generate a test output intended to cause an operation of the elevator system 1 to occur. The test unit 200 is further configured to receive a test input intended to confirm that the operation of the elevator system 1 did occur in response to the test output.

The test unit 200 may, therefore, include a housing 201 which is configured to contain one or more components of the test unit 200.

The test unit 200 may include a processor system 202 which may comprise microcontroller, microprocessor, and/or other processor 202a. The processor system 202 is configured to execute one or more instructions to cause the test unit 200 to perform the one or more functions of the test unit 200 described herein. Accordingly, the processor system 202 may include a computer readable medium 202b which is configured to store one or more of those instructions and which is communicatively coupled to the processor 202a. The processor system 202 may also include other memory, caches, and the like to enable its operation and the processing of the instruction(s) by the processor 202a. The processor system 202 may be contained within the housing 201.

The test unit 200 may include a first input connector 202c which may be communicatively coupled to the processor system 202. The first input connector 202c may be configured to be communicatively coupled to an output from a caller unit 14, which may be a caller unit 14 as described herein. The first input connector 202c is configured to receive the test command. Therefore, the first input connector 202c may be provided such that a received test command can be passed to the processor system 202. The caller unit 14 may be called by the call handler system 15 to provide the test command to the caller unit 14 (e.g. in the form of an encoded signal over a telephone communication channel).

The communicative coupling which may be provided between the first input connector 202c and the caller unit 14 may be a wired communicative coupling or may be a wireless communicative coupling.

In some embodiments, the caller unit 14 may be replaced by a communication system of the test unit 200. This communication system may use a wired or wireless network (or a combination of a wired and a wireless network) to connect to the call handler system 15 (which may be different from the call handler system 15 to which the caller unit 14 connects). The wireless network may include a cellular telephone network, for example. References herein to the caller unit 14 in relation to the operation of the test unit 200 should be construed as also being references to the communication system of the test unit 200.

In some embodiments, the first input connector 202c is provided within the housing 201. In some embodiments, the first input connector 202c is provided such that it is accessible through the housing 201 (to allow a wired connection without opening the housing 201).

In some embodiments, the test command is initiated after a predetermined period since an event and that event might have been, for example, an operation of the elevator car 11 such as a movement of the elevator car 11 or the operation of the elevator door 111 from the open to the closed configuration (or vice versa). Therefore, the first input connector 202c may be configured to receive an input which is internal to the test unit 200 in some embodiments. In some embodiments, the test unit 200 is pre-programmed with different predetermined periods of time since the last event before a test operation is triggered (if there is no new event in the interim). Each different period of time may be associated with a time of day, week, and/or year—such that the period of time is shorter during expected periods of peak use. In some embodiments, the test unit 200 is configured to monitor the occurrence of events and to determining one or more peak period of use and to associate the or each peak period of use with a corresponding period since the last even before a test operation is triggered. In other words, in some embodiments, the test unit 200 may be configured to learn when peak periods of use occur and may assign a period between an event and the triggering of the test operation based on the determined peak periods.

The test unit 200 may include a first output connector 202d which may be communicatively coupled to the processor system 202. The first output connector 202d may be configured to be communicatively coupled to the car operating panel 112 of the elevator car 11 with which the test unit 200 is associated. The first output connector 202d is configured to output the test output. Therefore, the first output connector 202d may be communicatively coupled to the processor system 202 such that a test output generated by the processor system 202 can be passed to the car operating panel 112.

The communicative coupling which may be provided between the first output connector 202d and the car operating panel 112 may be a wired communicative coupling or may be a wireless communicative coupling.

The test output (which is a signal) may cause the generation of a level request signal by the car operating panel 112 or may be a replicate of a level request signal which is sent to the main elevator controller 3. Thus, in some embodiments, the test output may replicate the actuation, by a user, of one of the buttons 112a of the car operating panel 112. The test output may achieve this in a number of different manners. In some embodiments, the test output may cause the actuation of a switch which, when actuated by the test output, causes the car operating panel 112 to behave as if a button 112a thereof has been actuated. This may be achieved by the switch being connected in a circuit with a switch of the car operating panel 112 which is associated with the button 112a of the car operating panel 112 (e.g. connected in parallel therewith in the electrical circuit).

In some embodiments, the test input may replicate the actuation of the button 112a and may transmit the level request signal (which may be referred to as a simulated level request signal) to the main elevator controller 3 such that the main elevator controller 3 treats this signal as if it were a level request signal output by the car operating panel 112.

It may be, therefore, that in some embodiments, the first output connector 202d may be configured to be communicatively coupled to the main elevator controller 3 rather than the car operating panel 112. Therefore, the first output connector 202d may be communicatively coupled to the processor system 202 such that a test output generated by the processor system 202 can be passed to the main elevator controller 3—the test output being, in some such embodiments, the simulated level request signal.

In some embodiments, such as those in which the first output connector 202d is configured to communicate with the main elevator controller 3, the processor system 202 may be configured to generate, selectively, more than one test output or, in other words, more than one different simulated level request signal. The different test outputs or simulated level request signals may be configured to cause the main elevator controller 3 to control the movement of the elevator car 11 to respective different levels 21. In some embodiments, the processor system 202 is configured to generate two different test outputs or simulated level request signals. Accordingly, the first output connector 202d may be configured to output the generated test outputs or simulated level request signals.

In some embodiments in which the first output connector 202d is communicatively coupled to the car operating panel 112, the test output may replicate the actuation, by a user, of two or more of the buttons 112a of the car operating panel 112, selectively. This may be achieved, for example, by the first output connector 202d being communicatively coupled to the car operating panel 112 through a test sub-unit 204 which is configured to receive the test output from the test unit 200 and to interpret that output to cause the replicated actuation of two or more of the buttons 112a of the car operating panel 112, selectively (e.g. using switches connected in parallel with switches associated with those buttons 112a) based on the received test output. The test sub-unit 204 may be a separate unit which is not provided within the housing 201. The test sub-unit 204 may be, for example, coupled to or provided as part of the car operating panel 112. The test sub-unit 204 may be, therefore, located behind the car operating panel 112 in some embodiments (and the test unit 200 may be located elsewhere such as on top of or underneath the elevator car 11 or in the machine room).

In some embodiments, however, the test unit 200 has a second output connector 202e which is communicatively coupled to the car operating panel 112 and may be so coupled to the processor system 202 in a corresponding manner to the first output connector 202d. The first output connector 202d may be used to replicate actuation of a first button 112a of the car operating panel 112 as described herein, and the second output connector 202e may be used to replicate actuation of a second button 112a of the car operating panel 112 in a corresponding manner. As will be understood, in some embodiments, the first and second output connectors 202d,e may be part of the same physical connector.

The communicative coupling which may be provided between the second output connector 202e and the car operating panel 112 may be a wired communicative coupling or may be a wireless communicative coupling.

In some embodiments, the first and/or second output connectors 202d,e are provided within the housing 201. In some embodiments, the first and/or second output connectors 202d,e are provided such that they are accessible through the housing 201 (to allow a wired connection without opening the housing 201).

As will be understood, therefore, the test operation of the elevator system 1 as instructed by the test unit 200 may be a test movement of the elevator car 11 between levels 21 (i.e. within the elevator shaft 12). This test operation may be instructed by the test unit 200 using at least one level request signal—which may be a level request signal from the car operating panel 112 or a simulated level request signal sent to the main elevator controller 3.

The test unit 200 may include a second input connector 202f which may be communicatively coupled to the processor system 202. The second input connector 202f may be configured to receive the test input indicating that the test operation (e.g. movement of the elevator car 11 is completed successfully).

The second input connector 202f could, therefore, be communicatively coupled to a number of different outputs from the elevator system 1 to confirm that the test operation has occurred. In some embodiments, the test unit 200 is configured to determine whether or not the test operation has occurred using an internal sensor—i.e. internal to the test unit 200.

In some embodiments, the test unit 200 is configured to receive a plurality of outputs which indicate whether or not the test operation has occurred and the test unit 200 may be configured to assess these outputs to determine whether the test operation occurred and/or the nature of any fault which may have occurred. This may include the use of one or more internal sensors and/or one or more external sensors.

In some embodiments, therefore, the second input connector 202f may be configured to be communicatively coupled to the door switch 134 of the elevator car 11 with which the test unit 200 is associated. The second input connector 202f may be communicatively coupled to the processor system 202 and the door switch 134, such that the current condition of the elevator door 111 may be passed to the processor system 202.

If the test operation was to move the elevator car 11 to another level 21 or even the current level 21 on which the elevator car 11 is located, then in ordinary operation the elevator door 11 would move to the open configuration once the elevator car 11 is at that level 21. Accordingly, the current configuration of the elevator door 111 may be an indication of whether or not the test operation occurred successfully.

In some embodiments, the second input connector 202f may be configured to be communicatively coupled to an operation determining sub-system 203 of the test unit 200. This operation determining sub-system 203 may be configured to determine the current level 21 of the elevator car 11 and/or to detect movement of the elevator car 11 between levels 21.

The operation determining sub-system 203 may be configured to provide this information (i.e. the current level 21 or a detected movement) to the processing unit 202. In some embodiments, therefore, the door switch 134 forms part of the operation determining sub-system 203.

The operation determining sub-system 203 may be located within the housing 201 of the test unit 200, for example.

The operation determining sub-system 203 may include one or more of an acceleration sensor, an air pressure sensor, and an encoded position indicator reader.

In embodiments in which the operation determining sub-system 203 includes an acceleration sensor, this may provide an indication of a detected acceleration of the elevator car 11 to the processor system 202. This is an indication that the elevator car 11 has moved. The indication may include a direction of acceleration which is then also provided to the processor system 202 to provide an indication of the direction of movement of the elevator car 11. In some embodiments, the operation determining sub-system 203 includes an acceleration profile for the elevator system 1 (which may be a profile associated with that elevator car 11 of the elevator system 1). This acceleration profile may include a record of the typical acceleration of the elevator car 11 over time as it moves between levels 21. Therefore, the operation determining sub-system 203 may be configured to provide the processor system 202 with an indication of the current level 21 of the elevator car 11 based on the acceleration profile and a measured acceleration of the elevator car 11. In some embodiments, a test sequence and/or registration process may have been implemented to generate the acceleration profile and/or to provide the operation determining sub-system 203 with an indication of the current level 21 at an initial time such that the subsequent location of the elevator car 11 can be determined using the acceleration profile. The test sequence may include a predetermined set of movements of the elevator car 11 and may be performed during a configuration process, for example.

In embodiments in which the operation determining sub-system 203 includes an air pressure sensor, this may provide an indication of a detected air pressure at the current location of the elevator car 11 to the processor system 202. A change in air pressure above a predetermined threshold may indicate a movement of the elevator car 11 and this may, therefore, be determined by the processor system 202 using the provided detected air pressure or may be determined by the operation determining sub-system 203 and provided to the processor system 202 as an indication of movement of the elevator car 11. In some embodiments, the operation determining sub-system 203 is configured to compare the detected air pressure to an air pressure profile for the elevator system 1 (which may be a profile which is associated with that elevator car 11 of the elevator system 1). The air pressure profile may provide an indication of the expected air pressure at different levels 21 and may be determined, like the acceleration profile, through a test sequence and/or registration process (which may include one or more predetermined movements of the elevator car 11 which may be during a configuration process, for example).

The air pressure profile may be normalised based on current climatic conditions using an air pressure sensor at a known position. That known position may be a fixed position or could be a predetermined position of the elevator car 11, for example.

In embodiments in which the operation determining sub-system 203 includes an encoded position indicator reader this may provide an indication of a detected level of the elevator car 11 to the processor system 202. The encoded position indicator reader may be configured to read an encoded position indictor provided within the elevator shaft 12. This may be provided in the form of a magnetically encoded tape or the like within the elevator shaft 12 and may be used by other parts of the elevator system 1 to determine the current location of the elevator car 11. In some embodiments, therefore, the encoded position indicator reader is provided as part of the elevator car 11 and the operation determining sub-system 203 includes a communicative coupling to that existing encoded position indicator reader.

In some embodiments, the operation determining sub-system 203 does not, therefore, determine the current level 21 of the elevator car 11 but can determine movement of the elevator car 11 or that the elevator car 11 has reacted correctly to a level request signal or simulated level request signal (e.g. by the opening of the elevator door 111 if the elevator car 11 is already at the requested level 21).

The operation determining sub-system 203 may detect a plurality of potential indicators of successful completion of the test operation. For example, in some embodiments, the operation determining sub-system 203 may be configured to provide the processor system 202 with an indication of the current configuration of the elevator door 111 and an indication of movement of the elevator car 11.

The processor system 202 is configured to receive the test output from the operation determining sub-system 203 and to determine if the test operation has been successfully performed. This may include determining whether the elevator car 11 has moved and/or whether the elevator car 11 has moved to the correct level 21 and/or whether the elevator door 111 has operated correctly (e.g. moved to the open configuration).

In some embodiments, the operation determining sub-system 203 may provide an initial condition input to the processor 202 (e.g. via the second input connector 202f). The initial condition input may include an initial condition of the operation of the elevator system 1 before the test operation is instructed by the test unit 200. This may include, for example, the current level 21 of the associated elevator car 11, for example.

In some embodiments, the second input connector 202f is provided within the housing 201. In some embodiments, the second input connector 202f is provided such that it is accessible through the housing 201 (to allow a wired connection without opening the housing 201). In some embodiments, the operation determining sub-system 203 includes components which are inside and outside the housing 201. Therefore, the operation determining sub-system 203 may include connectors to allow the connection of one or more external components (i.e. external to the housing 201) which may include, for example, the acceleration sensor, and/or the air pressure sensor, and/or the encoded position indicator reader (any or all of which may be provided within the housing 201 in some embodiments). The communicative coupling of these components may be through a wired or wireless communicative coupling.

After a test operation has been requested by the test unit 200, then a report may be sent to the caller unit 14 indicating whether the test operation was completed successfully. Accordingly, the test unit 200 may be communicatively coupled to the caller unit 14 through a third output connector 202g. In some embodiments, the third output connector 202g is part of an input-output connector of which the first input connector 202c also forms a part. The communicative coupling may be wired or wireless. In some embodiments, the third output connector 202g is provided within the housing 201. In some embodiments, the third output connector 202g is provided such that it is accessible through the housing 201 (to allow a wired connection without opening the housing 201).

The processor system 202 may be configured to generate the report based at least in part on the test input which may be received by the processor system 202 after at least one test output is sent by the processor system 202.

The report may indicate that the test operation was completed successfully. The report may indicate that the test operation was not completed successfully—i.e. that the instructed test operation did not occur.

In either case, the report may indicate the test input (or inputs) received by the processor system 202. The report may, therefore, include more than simple a pass or fail indicator. This may enable further information regarding the operation of the elevator system 1 to be understood or otherwise determined based on the report.

The report may be sent by the caller unit 14 to the call handler system 15, for example.

In use, therefore, an operator may use the call handler system 15 to send a command input to the test unit 200 through the caller unit 14. The test unit 200 may then initiate a test operation.

The operator may be reacting to, for example, a reported fault with the elevator system 1 and/or with a particular elevator car 11 of that elevator system 1.

The operator may be remotely located from the elevator system 1 and may be determining whether or not to schedule an engineer to attend the location of the elevator system 1.

The operator may, in this instance, be a computer program operating as part of the call handler system 15 such that this process is automated. In some embodiments, the process is partially automated and the actions may be at least partially controlled by a human operator.

In response to the received command input, the test unit 200 may initiate the requested test operation. In particular, the processor system 202 may generate and output one or more test outputs in response to the received command input.

The one or more test outputs may causing a level request signal or simulated level request signal to be generated, as discussed above, to cause movement of the elevator car 11.

In some embodiments, before the one or more test outputs are generated, the test unit 200 may determine the current condition of the elevator car 11—such as the current location of the elevator car 11. This may be achieved, for example, by the receipt of the initial condition input. The test unit 200 may issue a request to the operation determining sub-system 203 for the initial condition input, which may be sent in response to receipt of the request.

The one or more test outputs may be generated based at least in part on the received initial condition input. So, for example, a test output may be generated so that a level request signal or simulated level request signal is generated for a level 21 which is different to the current level 21 of the associated elevator car 11 as determined by the initial condition input.

In some embodiments, two different level request signals can be caused, selectively, through operation of the test unit 200. Accordingly, a movement to a level 21 other than the current level 21 of the elevator car 11 can be always be requested in such embodiments.

The test input may then be received and the report generated by the processor system 202.

In some embodiments, at least one test output may be generated based on the received test input from a preceding test output. For example, a first test output may cause the generation of a level request signal or simulated level request signal for a particular level 21. If the elevator car 11 is already at that level 21 then there may be no movement of the elevator car 11 detected. Therefore, the test input may indicate that the test operation was not completed. In response, the test unit 200 may generate a second test output which may cause the generation of a level request signal or simulated level request signal for a different particular level 21. If there is still no movement of the elevator car 11 determined then the test input may indicate this to the processor system 202 and the report may be generated and may be sent accordingly.

As will be appreciated, therefore, some embodiments may not require an initial condition input.

Accordingly, the operator may be able to use some embodiments to determine whether or not an elevator system 1 is functioning normally and, in particular, whether an elevator car 11 is able to move between levels 21.

The report may include information such as, for example, whether an elevator car 11 moved between levels 21 and whether the elevator door 111 moved between the open and closed configurations as expected (e.g. the door 111 opening on arrival at a destination level 21).

Some embodiments provide a relatively simple test unit 200 which does not necessarily require direct interaction with the main elevator controller 3. As such, the test unit 200 may be connected to the car operating panel 112 and a system for determining whether the test operation was successful performed (such as a connection to the operation determining sub-system 203). The triggering of a test operation and the reporting on the completion (or failed completion) of the test operation may be achieved via a connection to the caller unit 14.

This may allow some embodiments to be provided as an elevator car 11 mounted test unit 200.

As will be appreciated, the first input connector 202c represents a first input, the first output connector 202d and the second output connector 202e represent a first output, the second input connector 202f represents a second input, and the third output connector 202g represents a second output, in some embodiments.

Some false callouts are triggered by users of the elevator system 1 through the emergency intercom system 112c. In some such situations, a user may erroneously state that the elevator car 11 is not operating correctly—e.g. not moving and/or the door 111 is not opening.

In such situations, the operator may use embodiments (as described herein) to trigger a test operation of the elevator system 1—e.g. a test movement of the elevator car 11—of the associated elevator car 11. The resulting report may be used to determine whether there is, indeed, a fault with the elevator system 1.

Therefore, in some embodiments, a test operation may be triggered by use of the emergency intercom system 112c and may be remotely triggered in response to such use.

Elevator door 111 blockages are a common cause of perceived temporary faults with elevator systems 11. Therefore, there is a need to discourage users from blocking the elevator door 111 for an excessive period of time.

As such, an elevator door 111 may be configured to perform a nudge operation. In accordance with the nudge operation, the elevator door 111 may be closed—despite a blockage being detected by the door sensor 13. However, the door controller 111b and/or door driving mechanism 111c and/or main elevator controller 3 may operate such that the elevator door 111 is moved towards the closed configuration more slowly than normal and/or with less force than normal. When the elevator door 111 encounters an object blocking the door aperture 111a (e.g. by contact therewith), the nudge operation may cause the elevator door 111 to move to the open configuration. The door nudge operation may repeat this process with a view to discouraging anyone from blocking the elevator door 111 unnecessarily.

This nudge operation may be performed under the control of the door controller 111b and/or the main elevator controller 3.

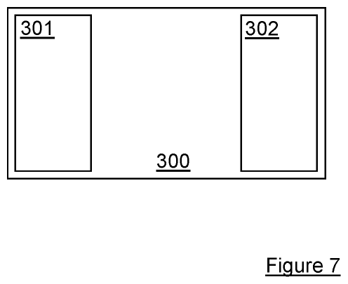

Some embodiments may, therefore, include a door blockage detection system 300 (see FIG. 7). The door blockage detection system 300 may be provided as part of the elevator system 1.

The door blockage detection system 300 may be secured to the elevator car 11 and may move with the elevator car 11 as it travels between levels 21.

The door blockage detection system 300 is configured to monitor one or more predetermined movements of the or each elevator door 111 of an elevator car 11 with which it is associated.

Accordingly, the door blockage detection system 300 may be communicatively coupled to the door sensor 13, such that the door blockage detection system 300 is configured to receive an indication from the door sensor 13 that the door aperture 111a is partially blocked or otherwise obstructed—e.g. that the light curtain has been interrupted.

The door blockage detection system 300 may be further configured, in some embodiments, to determine a width of the door aperture 111a—e.g. a distance between a leading edge of the elevator door 111 and a slam post or between to leading edges of two parts of the elevator door 111. As will be appreciated, the width of the door aperture 111a will change as the elevator door 111 moves between the open and closed configurations.

The door blockage detection system 300 may be configured to determine the width of the door aperture 111a based on a signal received from the door sensor 13 which is indicative of the width of the door aperture 111a. In some embodiments, the signal indicative of the width of the door aperture 111a is a direct indication of the width of the door aperture 111a as detected by the door sensor 13. In some embodiments, the signal indicative of the width of the door aperture 111a is a signal from which the width can be calculated by the door blockage detection system 300. Therefore, in these various embodiments, light intensity across the width of the door aperture 111a may be used to determine the width of the door aperture 111a by either the door blockage detection system 300 or the door sensor 13. The intensity of light across the width of the door aperture 111a may be the intensity of light received by the receiver 132 of the door sensor 13 from the transmitter 131. This intensity may be determined in relation to a part (or parts) of the door sensor 13 which are not obstructed by the object obstructing the elevator door 111. As will be appreciated, the intensity of light received by receiver 132 will increase as the door aperture 111a width decreases—so enabling determining of the width of the door aperture 111a.

The door blockage detection system 300 may be configured to monitor, therefore, one or more characteristic operations of the door sensor 13 to determine whether a nudge operation is occurring.

In particular, the door blockage detection system 300 may be configured to determine an event in which the door sensor 13 detects an obstruction of the elevator door 111 (e.g. using the received signal from the door sensor 13) and may be configured to detect when, despite their being a door blockage, the door aperture 111a width decreases (e.g. using the other signal received from the door sensor 13). In other words, the door blockage detection system 300 may be configured to determine when there is an obstruction of the elevator door 111 and yet the elevator door 111 is still moved (or advanced) towards the closed configuration.

The door blockage detection system 300 may be configured to detect a subsequent increase in the door aperture 111a width (e.g. using the signal indicative of this width)—in other words a movement of the elevator door 111 towards the open configuration (or a retreat of the elevator door 111).

The door blockage detection system 300 may be configured to detect a sequence of one or more such nudge operations and to determine when a predetermined number of such nudge operations have occurred. The predetermined number may be one, two, or more nudge operations (each nudge operation comprising one attempted closure of the elevator door 111 (i.e. an advance of the elevator door 111).

In some embodiments, the door blockage detection system 300 may be configured to determine that there is a blockage of the elevator door 111 if the predetermined number of nudge operations occurs.

In some embodiments, the door blockage detection system 300 may be configured to determine that there is a blockage of the elevator door 111 if the minimum door aperture 111a width is substantially the same for two nudge operations (which may be consecutive nudge operations), in which the elevator door 111 does not reach the closed configuration. If this minimum width changes, however, between nudge operations, then the door blockage detection system 300 may be configured not to determine there is a blockage and/or to identify the elevator door 111 as temporarily blocked (e.g. by a user).

In some embodiments, the door blockage detection system 300 may be configured to determine whether a nudge operation successfully resulted in the elevator door 111 reaching the closed configuration whilst, for example, a blockage remained detected—which may be an indicator of damage to the to the door sensor 13, for example. Therefore, the door blockage detection system 300 may be configured to identify damage to the door sensor 13. This damage may be a fault or may be, for example, an item stuck to the door sensor 13.

Accordingly, the door blockage detection system 300 may be configured to detect a blockage of the elevator door 111 and/or temporary blockage of the elevator door 111, and/or damage to a door sensor 13. The door blockage detection system 300 may be configured to generate a report indicating the detected status of the elevator door 111 and/or door sensor 13.

The door blockage detection system 300 may include a processor which is configured to execute one or more instructions to cause the operations and processes described herein in relation to the door blockage detection system 300. In some embodiments, the door blockage detection system 300 is embodied by those one or more instructions.

The door blockage detection system 300 may be communicatively coupled to a communication system 301. In some embodiments the communication system 301 is part of the door blockage detection system 301 (in which case, the processor thereof may be communicatively coupled to the communication system 301 and that processor may be the processor of the door blockage detection system 300 separate from a processor of the door controller 111c. In some embodiments, the communication system 301 may be the caller unit 14. In some embodiments, the communication system 301 is part of the door sensor 13. The communication system 301 may include, for example, a connection to a cellular telephone network and so the communication system 301 may be a cellular telephone network communication system.

The door blockage detection system 300 may be configured to send, using the communication system 301, the report to the call handler system 15. In some embodiments, the report is sent in the event of the predetermined number of detected nudge operations (e.g. a predetermined number of detected door advances). For example, the door blockage detection system 300 may be configured to send the report to the call handler system 15 when a blockage (which may be a detected temporary blockage), or fault is detected.

The report which is sent may include an identifier for the elevator car 11 in relation to which the potential obstruction has been detected—this may include an identifier for the elevator system 1 and/or an identifier for the elevator car 11. In some embodiments, the report may include the location of the elevator car 11 in the elevator shaft 12—which may be indicated by an identifier for the level 21 on which the elevator car 11 is located. The location of the elevator car 11 may be determined using the level determining sub-system 203 of the test unit 200 (if included in such embodiments). In some embodiments, the door blockage detection system 300 includes its own level determining sub-system which may operate in the same way and have the same elements as the level determining sub-system 203 of the test unit 200 (which may be the case in embodiments which do not (or which do) include the test unit 200).

In some embodiments, the door blockage detection system 300 includes a speaker, alarm or other audible output device 302. In some embodiments, the door blockage detection system 300 is communicatively coupled to the audible output device 302 which may form some other part of the elevator system 1 (e.g. which may be included in the car operating panel 112). The door blockage detection system 300 may be configured to cause the output of an audible alert using the audible output device 302 instead of or in addition to sending of the report. The description herein in relation to when a report may be sent applies equally to when the audible alert may be made.

In some embodiments, the door blockage detection system 300 may be configured to operate in this manner if there is only a partial blockage of door aperture 111a as determined by the door sensor 13 (i.e. not a complete blockage which may indicate failure of the door sensor 13). In some embodiments, the door blockage detection system 300 may be configured to operate in this manner if there is only a predetermined part of the door aperture 111a blocked (e.g. a lower part or a middle part or an upper part) as determined by the door sensor 13.

Embodiments which include the test unit 200 may or may not also include the door blockage detection system 300, and vice versa.

In some embodiments, the caller unit 14 and/or the call handler system 15 may be configured to handle emergency calls triggered through actuation of the emergency intercom button 112b in different manners depending on one or more different criteria.

For example, in some embodiments, the caller unit 14 may be communicatively coupled to the door switch 134 and/or to the test unit 200 (if provided and generally as described elsewhere herein). If the emergency intercom button 112b is actuated then the caller unit 14 may be configured to interrogate the door switch 134 to determine the current state of the elevator door 111 of the associated elevator car 11. The caller unit 14 may be configured to send an indication of the current configuration of the elevator door 111 to the call handler system 15.

If the elevator door 111 is in the open configuration, then the call handler system 15 may be configured to play a predetermined (i.e. recorded) message to the caller unit 14 which is then output through the emergency intercom system 112c (e.g. as an audible message). This message may confirm the connection has been made to the call handler system 15 successfully. In some embodiments, instead of or in addition to the door switch 134, the caller unit 14 may be communicatively coupled to the door sensor 13. Accordingly, an indication of whether or not the door aperture 111a is blocked may be sent by the caller unit 14 to the call handler system 15. The call handler system 15 may be configured to play the predetermined message based at least in part on whether or not the door aperture 111a is blocked (and/or whether the elevator door 111 is in the open configuration). In some embodiments, one or more other criteria have to be determined by the call handler system 15 and/or caller unit 14 in order to cause the playing of a predetermined message (instead of connecting to a human operator) and these one or more other criteria may include, for example, a predetermined time of day and/or day of the week (e.g. when tests are normally performed).

In some embodiments, the predetermined message may include one or more parts. The one or more parts may include a recorded voice message from a human operator, a battery status for the caller unit 14 (and/or the test unit 200), a line status confirmation message (i.e. a message confirming with the communication line to the call handler system 15 is operational).

In some embodiments, the call handler system 15 is configured to contact a human operator (e.g. by contacting a device of the human operator, such as by making a call to the human operator (who may be remotely located with respect to the call handler system 15 in this and other embodiments). This contact may be made periodically—e.g. at predetermined times and/or on predetermined days and/or at predetermined intervals (such as every day) or at random or pseudorandom intervals within a range (such as every day but at a random or pseudorandom time during that day). The contact may include the recording of the recorded voice message (i.e. the predetermined message). The contact may include the call handler system 15 prompting the human operator and/or their device to record a message. In some embodiments, the recorded message is not a voice message but is another indication of the answering of the contact attempt by the human operator. A failed or successful attempt may be recorded by the call handler system 15 and may be sent to a device used, owned, and/or operated by another person—such as a manager or owner of the building or elevator system 1. The other person can then readily see from the transmitted information whether the operator successful responded to the contact request.

If the elevator door 111 is in the closed configuration, then the call handler system 15 may be configured to connect the emergency intercom system 112c, via the caller unit 14, to a human operator such that a user of the elevator car 11 can communicate with the human operator and vice versa.

This selective playing of a predetermined message allows a user to open the elevator door 111 and to actuate the emergency intercom button 112b to test that actuation of the button 112b successfully connects the caller unit 14 to the call handler system 15. If the elevator door 111 is in the open configuration then it is unlikely that there is an emergency which requires use of the emergency intercom system 112c. This, therefore, not only allows testing but reduces the risk of false callouts.

If the test fails and the call handler system 15 cannot be contacted, then the caller unit 14 may be configured to issue a report on the failed connection. This report may be sent via a separate communication channel (i.e. different from that used to contact the call handler system 15) and/or may be to a different call handler system 15 (which may be part of a maintenance system). The report may be sent in the form of an email or the like, which may then be acted on by an engineer.

In some embodiments, if the predetermined message is played, then the message includes instructions for the user (which are output audibly through the emergency intercom system 112c to the user) to perform one or more actions to confirm that there is an emergency. This may include, for example, actuating the emergency intercom button again and/or for a predetermined time period. The caller unit 14 and/or the call handler system 15 may be configured to determine whether these one or more actions have been completed and may then connect the emergency intercom system 112c to the human operator (via the caller unit 14 and call handler system 15).

In some embodiments, the call handler system 15 (e.g. under direct instruction from a human operator) may be configured to cause a test operation of the elevator car 11 using the test unit 200. In particular, the call handler system 15 may be configured to cause such a test operation under instruction from the human operator when the emergency intercom system 112c of that elevator car 11 is being used to communicate with the human operator. Accordingly, the operator can, in some such embodiments, perform a test operation to determine whether or not the reported fault is actually occurring. Again, this may be used to reduce the occurrence of false callouts.

In some embodiments, the caller unit 14 may be configured, on actuation of the emergency intercom button 112b to instruct the test unit 200 to perform a test operation before the caller unit 14 connects to the call handler system 15. If the test operation completes successfully (and the elevator door 111 opens as a result), then the caller unit 14 may be configured not to connect to the call handler system 15. If the test operation fails to complete successfully (i.e. the elevator door 111 does not open as a result), then the caller unit 14 may then connect to the call handler system 15 (so that a user of the elevator car 11 can communicate with an operator). In some embodiments, the test unit 200 in such embodiments may be configured to instruct the opening of the elevator door 111 without also instructing movement of the elevator car 11 to another level 21 (e.g. without using a level request signal or simulated level request signal). To this end, the test unit 200 of such embodiments may not be configured to cause the issuance of a level request signal or simulated level request signal. The test unit 200 may be communicatively coupled to the door controller 111b and/or the door driving mechanism 111c such that an instruction can be sent by the test unit 200 to cause the opening of the elevator door 111. In some embodiments, the test unit 200 is configured to cause the generation of a signal from the car operating panel 112 for the elevator door 111 to open. In some embodiments, however, the test unit 200 causes the sending of a level request signal or a simulated level request signal for the current level 21 of the elevator car 11 in order to trigger the opening of the elevator door 111 (this may include the causing the issuance of a level request signal or a simulated level request signal for the current level 21 of the elevator car 11. In some embodiments, the test unit 200 may form part of the caller unit 14 such that the caller unit 14 can perform these functions.

In some embodiments, determining whether the elevator door 111 has moved from the closed to the open configuration may be determined as described elsewhere herein or may use a separate sensor (such as a further door switch (like door switch 134) which may be communicatively coupled to the caller unit 14 and/or the test unit 200.

In some embodiments, whether the predetermined message is played or the call connected to the call handler system 15 and/or to the operator, may be at least partially dependent on whether the elevator car 11 is moving and/or whether to the elevator car 11 is at a level 21. In particular, if the elevator car 11 is moving, then the elevator door 111 would not be openable. Therefore, the elevator door 111 not opening during a test operation whilst the elevator car 11 is moving is not an indication of a fault and so a call may not be connected to the call handler system 15 and/or to the operator (and the predetermined message may be played). If the elevator car 11 is at a level 21, then the elevator door 111 would, however, normally be openable. Therefore, if the elevator door 111 does not open during a test operation, then there is likely to be a fault and the call is connected to the call handler system 15 and/or to the operator. Likewise, if the elevator car 11 is stationary and the elevator door 111 does not open, then the caller unit 14 may connect the call to the call handler system 15 and/or to the operator.

The presence or not of a blockage within the door aperture 111a, as determined by the door sensor 13 for example, may be considered to be a status of the elevator door 111.

In some embodiments, the caller unit 14 may include a level determining sub-system 203 which may be of the same type as described in relation to the test unit 200. The level determining sub-system 203 may be used, as described, by the caller unit 14 to determine the current level 21 of the elevator car 11.

In some embodiments, the caller unit 14 may be configured to contact one or more different call handler systems 15 (e.g., by dialling different telephone numbers). When a call is made by the caller unit 14 and the elevator door 111 was open and/or could be opened, then a first call handler system 15 may be contacted (e.g. to provide the predetermined message) and when the call is made by the caller unit 14 with the elevator door 111 closed (or unable to be opened) then a second call handler system 15 may be contacted (e.g. to connect the user with an operator). The first call handler system 15 may be a maintenance call handler system 15 and the second call handler system 15 may be an emergency call monitoring call handler system 15, for example.

In some embodiments, the caller unit 14 may be configured to contact, e.g. call, the call handler system 15 (which may be the first call handler system 15) automatically (i.e. without user interaction with the emergency intercom button 112b). This automatic contact may be initiated at predetermined intervals and/or at random or pseudo-random intervals. The automatic contact may be used to determine one or more items of status information such as the current status of the communication line with the call handler system 15. In some embodiments, the caller unit 14 is configured, during such automatic communications with the call handler system 15 to communicate the current battery status for the caller unit 14 to the call handler system 15. In addition, one or more reports on the operation (or previous operations) of the caller unit 14 may be communicated to the call handler system 15 during such calls.

Thus, the caller unit 14 may be configured to communicate to the call handler system 15 one or more previous line failures in the connection between the caller unit 14 and the call handler system 15.

In some embodiments, the automatic contact may include automatic contact with the call handler system 15 which includes the operator (e.g. the second call handler system 15). The call handler system 15 may be configured to determine if the call is picked up by the operator. The call handler system 15 may configured to include this determined information in a report and that report may be sent, for example, to another call handler system 15 (such as the first call handler system 15).

Accordingly, the caller unit 14 may be configured to monitor (e.g. through periodic checks) and communicate the current status of the communication line to the call handler system 15, the status of a battery of the caller unit 14, and that an operator answers calls made by the caller unit 15 to the appropriate call handler system 15.

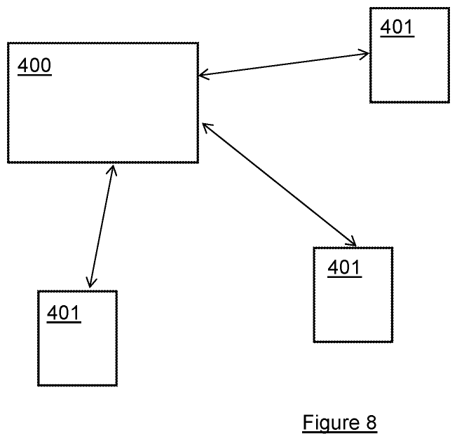

Some embodiments may include a monitoring system 400 (see FIG. 8, for example) which is configured to provide a user with information about the operational state of one or more elevator cars 11, elevator doors 111, and/or other parts of one or more elevator systems 1.

The monitoring system 400 may be provided on a server which may be part of the call handling system 15 or may be communicatively coupled thereto.

The monitoring system 400 may be configured to serve information to one or more other devices 401 which may be communicatively coupled to the monitoring system 400 (e.g. over a network which may include the Internet).

The one or more other device 401 may each include a mobile device such as a tablet computer, a mobile (i.e. cellular) telephone, a laptop, or the like. The or each other device 401 may be a computing device.

The or each other device 401 may be a device of a building owner or manager—the building 2 including the elevator system 1.

The monitoring system 400 may be configured to collate one or more reports as discussed herein. In particular, the monitoring system 400 may be configured to collate this information and provide the information to the or each other device 401.

The collated information may include an indication of the current operational state of the or each elevator car 11 of the elevator system 1. The current operational state may include whether the elevator car 11 is in an operational state (i.e. functioning normally). The operational state may include the current level 21 of the or each elevator car 11 of the elevator system 1.

In some embodiments, the collated information may include an operational state or condition of the elevator door 111 of the or each elevator car 11 of the elevator system 1—e.g. in the open or closed configuration (and/or blocked by an obstruction and/or if a fault is detected—as described elsewhere herein).

In some embodiments, the collated information may include information regarding the operation of the caller unit 14. In particular, the collated information may include the current or historic operational state of the communication line between the caller unit 14 and the call handler system 15, the current or historic operational state of the caller unit 14, the current or historical state (e.g. level of charge) of the battery of the caller unit 14, the current or historical result of any attempts to contact the operator (e.g. as described herein and which may be provided with the time and/or date of the failed attempt).

In some embodiments, the collated information is accessible from the or each other device 401. In some embodiments, the or each other device 401 is configured to receive one or more parts of the collated information and to present that information to the user of the other device 401 via a display of the other device 401. The or each other device 401 may be configured to provide a graphical user interface to enable the user to view and navigate through one or more parts of the collated information.

In some embodiments, the or each other device 401 may be configured to issue one or more requests to the monitoring system 400, wherein each request may relate to a part of the collated information.

In some embodiments, the monitoring system 400 is configured to monitor the collated information for one or more predefined events or sequences of events which indicate that user attention is required. If any such event or events is detected, then the monitoring system 400 may be configured to push an alert to one or more of the other devices 401 to alert the user and to bring the information (or part thereof) to the attention of the user. The one or more predefined events may include a blocked elevator door 111 (which may be a temporarily blocked elevator door 111) and/or a fault—e.g. as described herein. In some embodiments, the information which is provided by the monitoring system 400 to the or each other device 401 may include an identifier for the elevator system 1 and/or for the elevator car 11 and/or for the location of the elevator car 11 (e.g. the current level 21 of the elevator car 11). This information may also be provided in relation to information which is pulled (i.e. requested) by the or each other device 401 and sent, in response, by the monitoring system 400.

In various embodiments, reports are issued indicating potential faults with the elevator system 1. In some embodiments, these reports may be sent to a maintenance system automatically. The maintenance system may be configured automatically to perform one or more of: determining the nature of the fault, determining one or more likely causes of the fault, determining one or more replacement parts which may be needed, placing an order for one or more replacement parts, collating direct instructions for an engineer to follow to address the fault, identifying an appropriate engineer, scheduling a visit to the location of the elevator system 1 for an appropriate engineer, providing the engineer with the collated instructions, causing the provision of the one or more replacement parts to the engineer, and providing an update to a user on the scheduled visit.

Embodiments include the aforementioned elements and may also include the method of operating those elements.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An elevator test unit for testing the operation of an elevator system, the test unit including:
a first input configured to receive a command input instructing the performance of a test operation in relation to an elevator car associated with the test unit;
a first output configured, in response to receipt of the command input at the first input, to output a signal to cause the generation of a first level request signal or a first simulated level request signal to be sent to a main elevator controller to cause the test operation;
a second input configured to receive an indication of whether the test operation occurred successfully; and
a second output configured to output a report based on the received indication.

2. The elevator test unit according to claim 1, wherein the test unit is configured to be mounted to the elevator car.

3. The elevator test unit according to claim 1, wherein the first output is communicatively coupled to a car operating panel of the elevator car and the signal is configured to cause the generation of the first level request signal from the car operating panel.

4. The elevator test unit according to claim 1, wherein the first output is communicatively coupled to the main elevator controller and the signal is the first simulated level request signal.

5. The elevator test unit according to claim 1, wherein the second output is communicatively coupled to a caller unit associated with the elevator car, and the caller unit is configured to handle one or more emergency communication functions.

6. The elevator test unit according to claim 1, further including an operation determining sub-system which is communicatively coupled to the second input and which is configured to output the indication of whether the test operation occurred successfully.

7. The elevator test unit according to claim 6, wherein the operation determining sub-system includes one or more of an acceleration sensor, an air pressure sensor, an encoded position indicator reader, and a door switch.

8. The elevator test unit according to claim 6, wherein the indication of whether the test operation occurred successfully includes an indication of a movement of the elevator car and/or the operation of an elevator door of the elevator car.

9. The elevator test unit according to claim 1, wherein the first output is configured to cause the generation of a second level request signal to be sent to a main elevator controller, wherein the first level request signal is different to the second level request signal.

10. The elevator test unit according to claim 1, wherein the first output is configured to cause the generation of a second simulated level request signal to be sent to a main elevator controller, wherein the first simulated level request signal is different to the second simulated level request signal.

11. The elevator test unit according to claim 1, wherein the test unit is configured to generate the input command after a predetermined period has passed since an event detected by the test unit.

12. The elevator test unit according to claim 11, wherein the test unit is configured to detect a plurality of events, to determine a peak period based on the detected events, and to set the predetermined period based on the determined peak period.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. An elevator emergency call handler system configured to:
receive a call triggered by actuation of an emergency intercom button in an elevator car associated with the emergency call handler system;
receive an indication of at least one of: the current configuration or status of an elevator door associated with the elevator car, and a movement or location of the elevator car; and
selectively perform one of:
sending a predetermined message to an emergency intercom system associated with the elevator car for output using the emergency intercom system, and
connecting the emergency intercom system with an operator, depending on the received indication.

39. The emergency call handler system according to claim 38, wherein the indication is an indication of whether the elevator door is in an open configuration or a closed configuration.

40. The emergency call handler system according to claim 38, wherein the indication is an indication of whether a door sensor of associated with the elevator car detects an obstruction within a door aperture of the elevator door.

41. (canceled)

42. (canceled)

43. (canceled)

44. A caller unit configured to be mounted with respect to an elevator car, the caller unit being configured to be communicatively coupled to an emergency intercom button and an emergency intercom system of the elevator car, wherein the caller unit is further configured to:
initiate a call to a remote call handler system on actuation of the emergency intercom button;
send to the call handler system an indication of at least one of: the current configuration or status of an elevator door associated with the elevator car and a movement or location of the elevator car; and
receive an signal from the call handler system and to output that signal using the emergency intercom system.

45. The caller unit according to claim 44, wherein the indication is an indication of whether the elevator door is in an open configuration or a closed configuration.

46. The caller unit according to claim 44, wherein the indication is an indication of whether a door sensor of associated with the elevator car detects an obstruction within a door aperture of the elevator door.

47. (canceled)

48. (canceled)

49. (canceled)

50. (canceled)

51. (canceled)

52. (canceled)

53. (canceled)

54. A caller unit configured to be mounted with respect to an elevator car, the caller unit being configured to be communicatively coupled to an emergency intercom button and an emergency intercom system of the elevator car, wherein the caller unit is further configured to:
detect actuation of the emergency intercom button;
trigger a test operation of the elevator car based at least in part on the detection of the actuation of the emergency intercom button;
receive an indication of whether the test operation completed successfully; and
initiate a call to a remote call handler system selectively based on the received indication.

55. The caller unit according to claim 54, wherein the test operation includes opening an elevator door of the elevator car.

56. The caller unit according to claim 54 or 55, wherein the test operation includes movement of the elevator car to another level.

57. The caller unit according to claim 54, wherein the initiation of the call is triggered when the test operation fails.

58. An elevator emergency call handler system configured to:
initiate a contact attempt to a remote operator periodically;
record a response from the remote operator when the contact request is successful; and
perform at least one of sending the recorded response to a caller unit mounted with respect to an elevator car for output using an emergency intercom system of the elevator car, and notifying another device of the success or failure of the contact attempt.

59. (canceled)

60. (canceled)

61. (canceled)

62. (canceled)
